(19) United States
(12) Patent Application Publication
(10) Pub. No.: US 2024/0204377 A1
(43) Pub. Date: Jun. 20, 2024

(54) POLYMERIC MICROSPHERE-COATED ANODE

(71) Applicant: FORD GLOBAL TECHNOLOGIES, LLC, Dearborn, MI (US)

(72) Inventors: Insik JEON, Novi, MI (US); Ann Marie STRACCIA, Southgate, MI (US); Mark Edward NICHOLS, Saline, MI (US); Paul John BOJANOWSKI, Macomb Township, MI (US); Christopher Michael SEUBERT, New Hudson, MI (US)

(73) Assignee: FORD GLOBAL TECHNOLOGIES, LLC, Dearborn, MI (US)

(21) Appl. No.: 18/068,543

(22) Filed: Dec. 20, 2022

(51) Int. Cl. H01M 50/581; H01M 4/04; H01M 10/0525; H01M 50/46

(52) U.S. Cl. CPC H01M 50/581; H01M 4/0404; H01M 10/0525; H01M 50/46

(57) ABSTRACT

A lithium-ion battery cell includes a positive electrode including a positive electrode active material, a negative electrode including a negative electrode active material, a polymer-containing layer interposed between the positive electrode and the negative electrode, and an electrolyte contacting the positive electrode and the negative electrode. The polymer-containing layer includes a polymeric composition having a melting point from about 80° C. to about 170° C. The electrolyte includes lithium ions that are transported between the negative electrode and the positive electrode, Advantageously, lithium ion transport is stopped upon melting of the polymeric composition. A method for forming the lithium-ion battery cell is also provided.

### TECHNICAL FIELD

In at least one aspect, the present invention is related to negative electrodes for lithium-ion batteries.

### BACKGROUND

Lithium-ion batteries often include separators interposed between a positive electrode and a negative electrode. Conventional separators are typically composed of polymers that melt at relatively high temperatures that are undesirable for other battery components.

Accordingly, there is a need for battery designs that are resistant to high temperatures.

### SUMMARY

In at least one aspect, a lithium-ion battery cell with lithium-ion transport modification is provided. The lithium-ion battery cell includes a positive electrode including a positive electrode active material, a negative electrode including a negative electrode active material, a polymer-containing layer interposed between the positive electrode and the negative electrode, and an electrolyte contacting the positive electrode and the negative electrode. The polymer-containing layer includes a polymeric composition having a melting point from about 80° C. to about 170° C. The electrolyte includes lithium ions that are transported between the negative electrode and the positive electrode. Advantageously, lithium-ion transport is stopped upon melting of the polymeric composition.

In another aspect, a method for forming the lithium-ion battery cell set forth herein is provided. The method includes a step of applying a slurry to a negative electrode, the slurry including a liquid carrier and a polymeric composition having a melting point from about 80° C. to about 170° C. The slurry is allowed to solidify and/or cured to form a negative electrode assembly including a polymer-containing layer disposed over the negative electrode, the polymer-containing layer including a polymeric composition having a melting point from about 80° C. to about 170° C. A positive electrode is combined with the negative electrode assembly to form a lithium-ion battery cell.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A. Schematic of a negative electrode assembly that includes a polymer-containing layer.

FIG. 1B. Schematic of a negative electrode assembly that includes a polymer-containing layer.

FIG. 2. Schematic of a lithium-ion battery cell that includes a negative electrode assembly that includes a polymer-containing layer without a separator.

FIG. 3. Schematic of a lithium-ion battery cell that includes a negative electrode assembly that includes a polymer-containing layer with a separator.

FIG. 4A. Schematic of the assembling of a lithium-ion battery cell that includes a negative electrode assembly that includes a polymer-containing layer with a separator.

FIG. 4B. Schematic of the assembling of a lithium-ion battery cell that includes a negative electrode assembly that includes a polymer-containing layer without a separator.

FIG. 4C. Schematic of the assembling of a lithium-ion battery cell that includes a negative electrode assembly that includes a polymer-containing layer without a separator.

FIG. 5. Schematic depicting the rapid thermal shutdown of polymer-containing layer.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “positive electrode” means a battery cell electrode from which current flows out when the lithium-ion battery cell or battery is discharged. Sometimes a “positive electrode” is referred to as a “cathode.”

The term “negative electrode” means a battery cell electrode to which current flows in when the lithium-ion battery cell is discharged. Sometimes a “negative electrode” is referred to as an “anode.”

The term “cell” or “battery cell” means an electrochemical cell made of at least one positive electrode, at least one negative electrode, an electrolyte, and a separator membrane.

The term “battery” or “battery pack” means an electric storage device made of at least one battery cell. In a refinement, “battery” or “battery pack” is an electric storage device made of a plurality of battery cells.

### Abbreviations

“PVDF” means polyvinylidene.

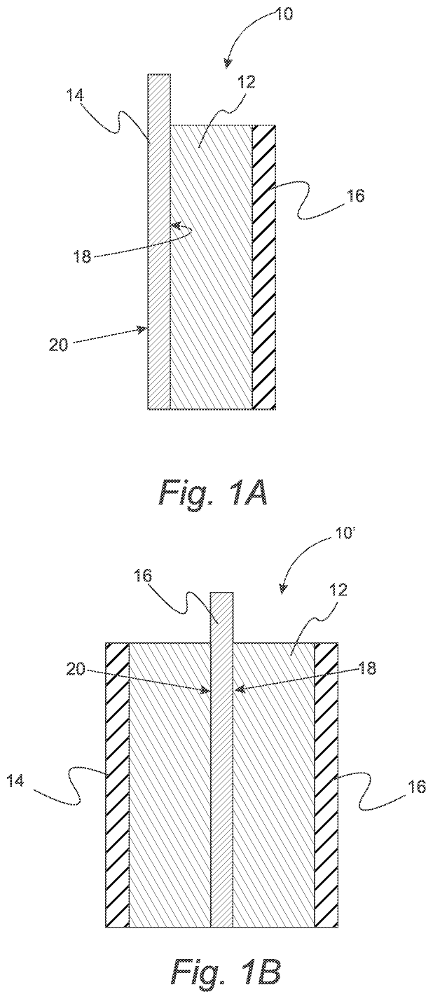

Referring to FIGS. 1A and 1B, schematics of positive electrodes for a lithium-ion battery cell are provided. Negative electrode assemblies 10 and 10′ each independently include negative electrode active material 12 disposed over and optionally contacting negative electrode current collector 14. Polymer-containing layer 16 is disposed over and optionally contacting negative electrode active material 12. FIG. 1A depicts the combination of negative electrode active material 12 and polymer-containing layer 16 disposed over a single face 18 of negative electrode current collector 14. Advantageously, the negative electrodes of FIGS. 1A and/or FIG. 1B can be incorporated into a lithium-ion battery cell.

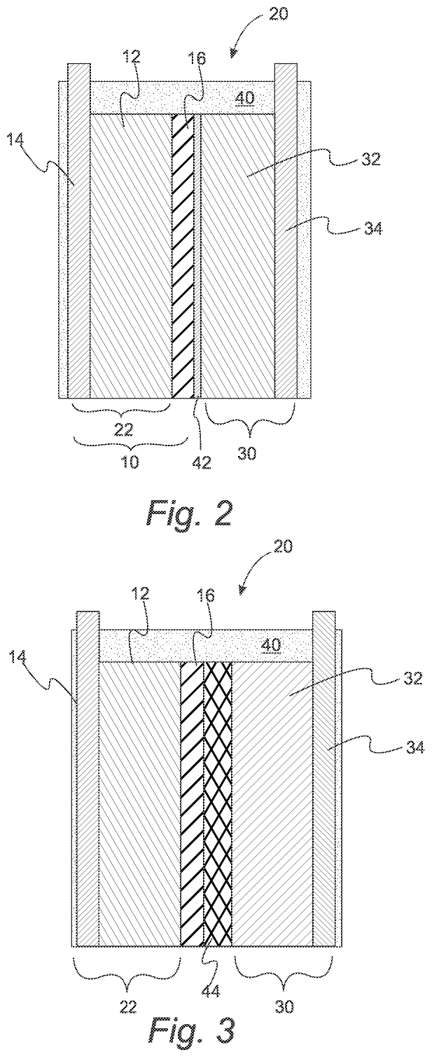

Referring to FIGS. 2, 3, 4A, 4B, and 4C, schematics of lithium-ion battery cells incorporating an anode depicted in FIG. 1A are provided. Lithium-ion battery cell 20 includes negative electrode 22, which includes negative electrode current collector 14 and negative electrode material 12. Negative electrode material 12 is disposed over and optionally contacts the negative electrode current collector. Lithium-ion battery cell 20 also includes a positive electrode 30, which includes a positive electrode active material 32. Positive electrode active material 32 is disposed over and optionally contacting positive current collector 34. Polymer-containing layer 16 is interposed between, and optionally contacts the positive electrode and the negative electrode. Advantageously, the polymer-containing layer 16 includes a polymeric composition having a melting point from about 80° C. to about 170° C. Collectively, negative electrode 22 and polymer-containing layer 16 can be identified as a positive electrode assembly 10 from FIG. 1A. Electrolyte 40 contacts the positive electrode and the negative electrode. Characteristically, electrolyte 40 includes lithium ions that are transported between the negative electrode and the positive electrode, wherein lithium ion transport is stopped upon melting of the polymeric composition. In a variation, the polymer-containing layer 16 is coated onto the negative electrode. In a refinement, optional adhesive layer 42 is used to adhere positive electrode 30 to poly polymer-containing layer 16.

In one variation, as depicted in FIG. 2, the lithium-ion battery cell 20 does not include a separator. In the variation depicted in FIG. 3, separator 42 is interposed between the polymer-containing layer 16 and the positive electrode 30.

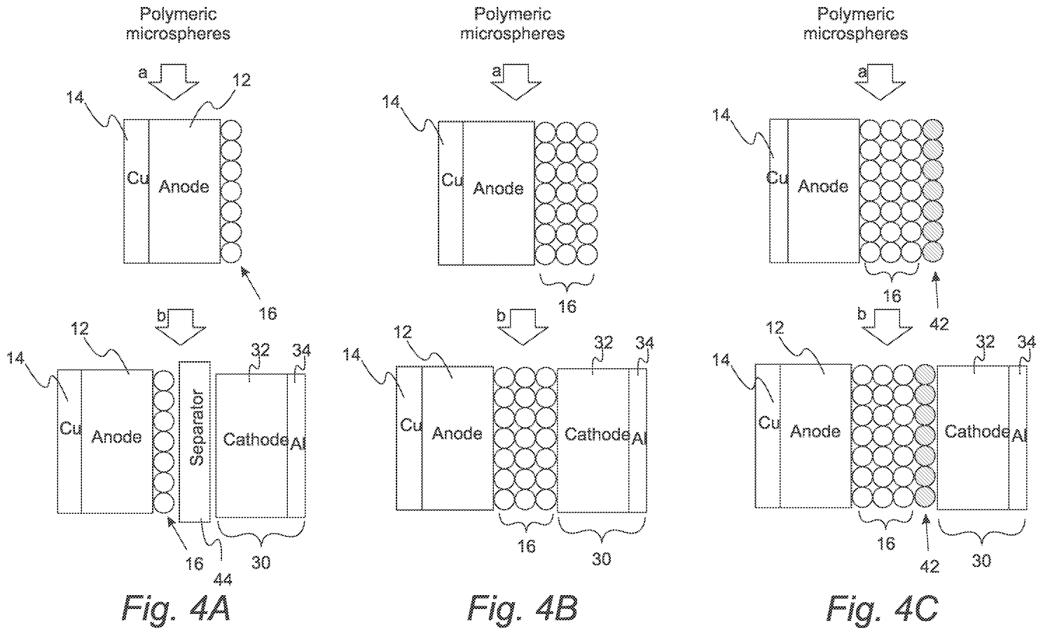

Referring to FIGS. 4A, 4B, and 3C, methods of assembling battery cells 20 are also schematically illustrated. In FIGS. 4A and 4B, positive electrode 10 is prepared by coating microspheres onto positive electrode active material 12 to form the polymer-containing layer 16. In the example FIG. 4A, the thickness of polymer-containing layer 16 is from about 0.3 to 2 microns. In the example FIG. 4B, the thickness of polymer-containing layer 16 is from about 5 to 10 microns. In the method depicted in FIG. 4A, separator 44 is positioned between positive electrode 30 and negative electrode 22. In FIG. 4C, positive electrode 10 is prepared by coating microspheres onto positive electrode active material 12 to form polymer-containing layer 16. Adhesive layer 42 is applied over the polymer-containing layer 16. In the example FIG. 4C, the thickness of polymer-containing layer 16 is from about 5 to 10 microns. In step b), the polymer-containing layer 16 is adhered to positive electrode 30 via adhesive layer 42. In a refinement, adhesive layer 42 includes an adhesive polymer such as PVDF.

As set forth above, the melting point of the polymeric composition is from about 80° C. to about 170° C. In a refinement, the melting point of the polymeric composition is from about 110° C. to about 130° C. In some refinements, the melting point of the polymeric composition is at least 70° C., 80° C., 90° C., 100° C., or 110° C. and at most 200° C., 180° C., 170° C., 150° C., or 130° C.

In another aspect, polymer-containing layer 16 has a thickness from 0.1 microns to 30 microns.

In another aspect, the polymer-containing layer 16 includes polymeric microspheres (i.e., microspheres composed of a polymer). In a refinement, the polymeric composition are composed of (or include) a polyolefin. In a further refinement, the polymer-containing layer 16 further includes ceramic particles. In still a further refinement, the ceramic particles have an average particle size from 0.1 micron to 2 micron. The ceramic particles can include a component selected from the group consisting of alumina, boehmite, or silica, and combinations thereof.

In another aspect, the polymer-containing layer further includes a binder. Examples of suitable binders include a component selected from the group consisting of carboxymethyl cellulose, methylcellulose, styrene-butadiene rubber, poly(vinyl alcohol), polyvinylpyrrolidone, fluoropolymers, acrylics, polyurethane, polyacrylamide, elastomers, curable monomers, and combinations thereof.

Referring to FIGS. 4A, 4B, and 3C, in each version of step a), A slurry is applied to a negative electrode. Typically, the slurry, including a liquid carrier and a polymeric composition having a melting point from about 80° C. to about 170° C. Typically, the slurry includes solids in the following amounts: polyolefins in an amount from about 70 to 99 wt %, binder in an amount from about 0.5 to 10 wt %, and ceramic particles in an amount from about 0.5 to 20 wt %. The solids are dispersed in a liquid carrier such as water or an alcohol (e.g., ethanol or methanol). The slurry is allowed to solidify and/or cure to form a negative electrode assembly including a polymer-containing layer disposed over the negative electrode, the polymer-containing layer including the polymeric composition. Moreover, in each version of step b), a positive electrode is combined with the negative electrode assembly to form a lithium-ion battery cell.

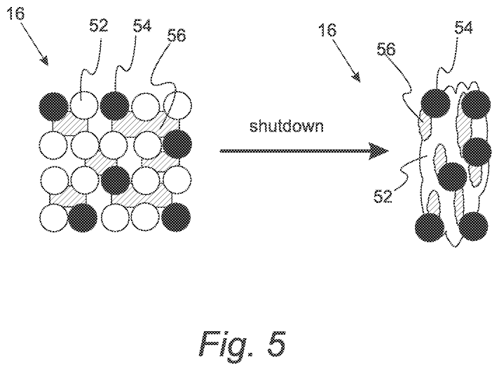

Referring to FIG. 5, a schematic depicting the rapid thermal shutdown of polymer-containing layer is provided. In this example, polymer-containing layer 16 includes polymeric particles 52 (e.g., polymeric microspheres) composed of a polymeric composition, ceramic particles 54, and binder 56. When the temperature within a battery cell exceeds the melting point of the polymeric composition, lithium-ion transport from the positive electrode to the negative electrode ceases or is significantly inhibited because the polymer composition melts, thereby blocking pores in polymer-containing layer 16.

As set forth above, the battery cells include an electrolyte having a lithium salt dissolved therein. Therefore, lithium ions can intercalate into the positive electrode active material during charging and into the negative electrode active material during discharging. Examples of lithium salts include but are not limited to LiPF₆, LiBF₄, LiSbF₆, LiAsF₆, LiCAF₉SO₃, LiClO₄, LiAlO₂, LiAlCl₄, LiCl, LiI, LiN(SO₂CF₃)₂, LiN(SO₂F)₂, and combinations thereof. In a refinement, the first electrolyte composition, the second electrolyte composition, and the final electrode composition independently include the lithium salt in an amount from about 0.1 M to about 2.0 M.

Referring to FIGS. 2 and 3, the negative electrode 22 and the positive electrode 30 can be fabricated by methods known to those skilled in the art of lithium-ion batteries. Typically, an active material (e.g., the positive or negative electrode active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 2 and 3, the positive electrode active material layer 32 includes positive electrode active material, a binder, and a conductive material. The positive electrode active materials used herein can be those positive electrode materials known to one skilled in the art of lithium-ion batteries. In particular, the positive electrode 30 may be formed from a lithium-based active material that can sufficiently undergo lithium intercalation and deintercalation. The positive electrode active material 32 can include one or more transition metals, such as manganese (Mn), nickel (Ni), cobalt (Co), chromium (Cr), iron (Fe), vanadium (V), and combinations thereof. Common classes of positive electrode active materials include lithium transition metal oxides with layered structure and lithium transition metal oxides with spinel phase. Examples of lithium transition metal oxides with layered structure include, but are not limited to lithium cobalt oxide (LiCoO₂), lithium nickel oxide (LiNiO₂), a lithium nickel manganese cobalt oxide (e.g., Li(NiₓMn_{y}Co_{z})O₂), where 0≤x≤1, 0≤y≤1, 0≤z≤1, and x+y+z=1), a lithium nickel cobalt metal oxide (e.g., LiNi_{(1-x-y)}CoₓM_{y}O₂), where 0<x<1, 0<y<1 and M is Al, Mn). Other known lithium-transition metal compounds such as lithium iron phosphate (LiFePO₄) or lithium iron fluorophosphate (LizFePO₄F) can also be used. In certain aspects, the positive electrode active material 32 may include an electroactive material that includes manganese, such lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide. Additional examples of positive electrode active material include but are not limited to lithium nickel cobalt manganese oxide (NCM), lithium nickel cobalt aluminum oxide (NCA), lithium nickel cobalt manganese aluminum oxide (NCMA), or combinations thereof.

The binder for the positive electrode active material can increase the binding properties of positive electrode active material particles with one another and with the positive electrode current collector 34. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, carbon nanotubes, and the like.

Referring to FIGS. 1A, 1B, 2 and 3, the negative electrode active material layer 12 includes a negative electrode active material, a binder, and optionally a conductive material. The negative electrode active materials used herein can be those negative materials known to one skilled in the art of lithium-ion batteries. Negative active materials include but are not limited to, carbon-based negative electrode active materials, silicon-based negative electrode active materials, and combinations thereof. A suitable carbon-based negative electrode active material may include graphite and graphene. A suitable silicon-based negative electrode active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 2. Mixtures of carbon-based negative electrode active materials, silicon-based negative electrode active materials can also be used for the negative electrode active material.

The negative electrode binder binds negative electrode active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol, carboxymethyl cellulose, and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lithium-ion battery cell comprising:
a positive electrode including a positive electrode active material;
a negative electrode including a negative electrode active material;
a polymer-containing layer interposed between the positive electrode and the negative electrode, the polymer-containing layer including a polymeric composition having a melting point from about 80° C. to about 170° C.; and
an electrolyte contacting the positive electrode and the negative electrode, the electrolyte including lithium ions that are transported between the negative electrode and the positive electrode, wherein lithium ion transport is stopped upon melting of the polymeric composition.

2. The lithium-ion battery cell of claim 1, wherein the polymer-containing layer is coated onto the negative electrode.

3. The lithium-ion battery cell of claim 1, wherein the lithium-ion battery cell does not include a separator.

4. The lithium-ion battery cell of claim 1 further comprising a separator interposed between the polymer-containing layer and the positive electrode.

5. The lithium-ion battery cell of claim 1, wherein the melting point of the polymeric composition is from about 110° C. to about 130° C.

6. The lithium-ion battery cell of claim 1, wherein the polymer-containing layer has a thickness from 0.1 microns to 30 microns.

7. The lithium-ion battery cell of claim 1, wherein the polymer-containing layer includes polymeric microspheres.

8. The lithium-ion battery cell of claim 1, wherein the polymeric composition includes a polyolefin.

9. The lithium-ion battery cell of claim 1, wherein the polymer-containing layer further includes ceramic particles.

10. The lithium-ion battery cell of claim 9, wherein the ceramic particles have an average particle size from 0.1 micron to 2 micron.

11. The lithium-ion battery cell of claim 9, wherein the ceramic particles include a component selected from the group consisting of alumina, boehmite, or silica, and combinations thereof.

12. The lithium-ion battery cell of claim 9, wherein the polymer-containing layer further includes a binder.

13. The lithium-ion battery cell of claim 12, wherein the binder includes a component selected from the group consisting of carboxymethyl cellulose, methylcellulose, styrene-butadiene rubber, poly(vinyl alcohol), polyvinylpyrrolidone, fluoropolymers, acrylics, polyurethane, polyacrylamide, elastomers, curable monomers, and combinations thereof.

14. The lithium-ion battery cell of claim 1, wherein the positive electrode comprises a positive electrode current collector and a positive electrode active layer disposed over the positive electrode current collector and the negative electrode comprises a negative electrode current collector and a negative electrode active layer disposed over the negative electrode current collector.

15. A method comprising:
applying a slurry to a negative electrode, the slurry including a liquid carrier and a polymeric composition having a melting point from about 80° C. to about 170° C.; and
allowing the slurry to solidify and/or cure to form a negative electrode assembly including a polymer-containing layer disposed over the negative electrode, the polymer-containing layer including the polymeric composition; and
combining a positive electrode with the negative electrode assembly to form a lithium-ion battery cell.

16. The method of claim 15, wherein a separator is positioned between the negative electrode assembly and the positive electrode.

17. The method of claim 15, wherein the melting point of the polymeric composition is from about 110° C. to about 130° C.

18. The method of claim 15, wherein the polymer-containing layer includes polymeric microspheres.

19. The method of claim 15, wherein the polymer-containing layer further includes ceramic particles.

20. The method of claim 15, wherein the slurry includes solids in an amount of polyolefins from about 70 to 99 wt %, binder from about 0.5 to 10 wt %, and ceramic particles from about 0.5 to 20 wt %.
